(19) United States
(12) Patent Application Publication
(10) Pub. No.: US 2005/0240455 A1
(43) Pub. Date: Oct. 27, 2005

(54) Method and system for receiving and analyzing an electronic personal statement

(76) Inventors: Alyssa Walters, Philadelphia, PA (US); Janice Plante, Newton, PA (US); Patrick Kyllonen, Lawrenceville, NJ (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/830,670

(22) Filed: Apr. 23, 2004

(51) Int. Cl. G06F 17/60

(52) U.S. Cl. 705/7

(57) ABSTRACT

A method and system for receiving and analyzing an electronic personal statement is disclosed. An evaluating entity selects one or more attributes used to assess applicants. A plurality of questions and associated response-options are generated based on the one or more attributes. The electronic personal statement includes the questions, response-options and an open-ended entry space for receiving descriptive text. An applicant completes the electronic personal statement on an applicant client system and transmits the statement to a data server accessible by the entity via a communications network. Optionally, one or more evaluators complete validation forms that provide each evaluator's assessment of the applicant's possession of the desired attributes. An entity can analyze a plurality of personal statements and compare the response-options or attributes individually or collectively across multiple personal statements. The entity can further analyze an applicant's response-options in light of the responses on one or more evaluators' validation forms.

### TECHNICAL FIELD

The present invention generally relates to the fields of data collection, management and validation. The present invention particularly relates to a method and system for providing and managing the form of an applicant's personal statement to permit a more focused analysis of the statement by an entity.

### BACKGROUND

Various types of entities, such as businesses, educational institutions, governmental agencies, military branches and the like, or divisions of an entity, such as a department of a university, a division of a business and the like, generate application forms that are completed by applicants for positions offered by the entity. The application forms may be one component of an evaluation process of the applicant for one or more positions offered by the entity. Currently, application forms are created to obtain self-reported information from applicants. Personal statement essays may be included as part of the application form so that applicants can supply information that may not be reflected in quantitative selection criteria, such as standardized test scores and grade point averages.

Generally, personal statements allow an applicant to select from a series of topics selected by the entity. As a result, applicants can describe experiences or other personal information that may assist them in obtaining the position for which they are applying, but are not otherwise requested by the application materials. An entity can also use the personal statement to evaluate the writing style or ability of the applicant.

Although the personal statement is open-ended in nature, an examiner typically is required to assign a rating to the personal statement because educational institutions or employing entities are often held accountable for decisions on applicants. The rating system could be a point system or some other quantifying strategy. In addition, personal statements from many applicants may not be read thoroughly due to time constraints. Thus, the effect of some of the primary benefits of open-ended personal statements may be lessened by these circumstances.

Moreover, the value of the personal statement depends upon the subjective interpretation of the person reading it. For example, an applicant's life experience could be of great interest to one person, but of little interest or even of offense to another person having a dissimilar background or belief system.

Personal statements are also subject to plagiarism or fabrication because the background facts are often unavailable to the reader of the essay. As such, although the subject matter of the personal statement is supposed to be the applicant and the applicant's experiences, the information may be untrue, exaggerated, or be drawn from the experiences of another individual. As a result, the application examiner may be misinformed regarding an applicant's background, which subverts one of the primary goals of the personal statement.

Current application services, such as Embark, Apply Yourself, and XAP, provide the ability to complete an application online. Each of theses services permits a user to print a copy of a paper form with one or more essay topics. Additionally, these services each allow an applicant to author a personal statement on paper and to return the personal statement to the entities to which the applicant is applying.

However, none of these services permit a user to electronically author, submit and/or validate personal statements. Moreover, the services do not provide applicant personal statement information in a standardized format.

What is needed is a method and system of providing queries and receiving information pertaining to an applicant that permits efficient review of the information by the entity in a quantifiable format.

A need exists for a method and system of efficiently and securely reviewing such information over the Internet.

A need also exists for a method and system for limiting the effect of subjective reader interpretations on the assessment of an applicant's personal information.

A further need exists for a method and system for providing independent validation of an applicant's electronic personal statement

A further need exists for a method and system for interactively managing data pertaining to electronic personal statements so that determinations of an applicant's acceptability for an entity's available positions may be made more efficiently.

A still further need exists for a method and system for reducing the likelihood of plagiarism, deceit or identity swapping by an applicant in a personal statement.

The method and system of the present invention is directed toward solving one or more of these problems.

### SUMMARY

Before the present methods, systems and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an” and “the” include plural references unless the context clearly dictates otherwise. Thus, for example, reference to a “personal statement” is a reference to one or more personal statements and equivalents thereof known to those skilled in the art, and so forth. Unless defined otherwise, all technical and scientific terms used herein have the same meaning as commonly understood by one of ordinary skill in the art. Although any methods, materials and devices similar or equivalent to those described herein can be used in the practice or testing of embodiments of the present invention, the preferred methods, materials and devices are now described. All publications mentioned herein are incorporated by reference. Nothing herein is to be construed as an admission that the invention is not entitled to antedate such disclosure by virtue of prior invention.

The methods and systems described herein are designed to replace methods and systems for creating personal statements completed by applicants to various entities. An electronic personal statement may supply useful information to an entity that cannot otherwise be elicited using traditional processes. For example, if an entity desires third party validation of the information provided by the applicant, such information may be solicited from one or more evaluators according to the present invention. The present invention further packages applicant information in a quantifiable format supplemented by open-ended comment sections. Increased accountability, reduced ambiguity, and a shorter review period for an application may each be advantages of the present methods and systems over current processes. Moreover, exaggeration, plagiarism, and falsified statements by applicants may be less likely to occur, particularly where evaluators provide supplemental information regarding an applicant.

Applicants may describe themselves based on a set of dimensions that the entity deems important for decision-making using a set of behavioral rating scales and an open-ended comment space. The output generated for the entity may be a Web-based interactive report of applicant information that provides more assessment information, is more reliable, and is less cumbersome than current personal statement assessment processes. If an electronic personal statement reviewer desires validation of the self-reported information by an applicant, the self-reported information may be sent to, for example, three adults, such as teachers, community leaders and employers, who may validate that the applicant's submission, including any listed accomplishments and activities, are accurate.

In an embodiment, a method of creating an electronic personal statement includes defining one or more attributes of interest to an entity, generating a first plurality of questions based on the one or more attributes, each question having a plurality of response options, generating an electronic personal statement template including the first plurality of questions, and receiving, from an applicant, an electronic personal statement having one or more responses for at least one of the first plurality of questions. The method may further include receiving, from the applicant, a fee for processing the electronic personal statement. The method may further include validating the data entered by the applicant. Validating the data may comprise generating a second plurality of questions based on the one or more attributes, each question having a plurality of response options, generating an electronic validation template based on the second plurality of questions, and receiving, from an evaluator, an electronic validation form having one or more second responses for at least one of the second plurality of questions. Defining one or more attributes may include creating one or more entity accounts, receiving from the entity a selection of the one or more attributes, and storing the selected one or more attributes in the entity account. Creating one or more entity accounts may include receiving information including identification of the entity, and identification of one or more individuals authorized to select the one or more attributes on behalf of the entity. In an embodiment, the one or more attributes are unalterable for a period of time. In an embodiment, the period of time is designated by the entity. Generating a first plurality of questions may include categorizing the one or more attributes into one or more categories, and retrieving one or more questions from a database of questions for each of the one or more categories. Generating the electronic personal statement template may include listing the first plurality of questions, listing one or more possible response options for each of the first plurality of questions, and providing at least one open-ended entry space. Receiving data from an applicant may include receiving, from the applicant, selected response options to one or more of the first plurality of questions, and receiving response information entered by the applicant into the at least one open-ended entry space.

In an embodiment, a method of assessing applicants based on at least an electronic personal statement includes electronically receiving a plurality of electronic personal statements, and assessing one or more of the electronic personal statements with respect to one or more attributes. Each electronic personal statement includes at least one first response-option for each of a first plurality of questions and at least one open-ended response. Each electronic personal statement is received from one of a plurality of applicants. Assessing one or more of the electronic personal statements may include reviewing the one or more first response-options for each electronic personal statement, reviewing the at least one open-ended response for each electronic personal statement, and determining one or more ratings for each electronic personal statement. Assessing one or more of the electronic personal statements may include comparing at least one first response-option for a first electronic personal statement with at least one corresponding first response-option for one or more second electronic personal statements. Assessing one or more of the electronic personal statements may alternately include comparing at least one first response-option for an electronic personal statement with normative information. In an embodiment, normative information includes response-options submitted by one or more applicants. In an embodiment, the method further includes electronically receiving one or more validation forms associated with each electronic personal statement, and determining whether each second response-option corresponds to at least one first response-option. Each validation form includes at least one second response-option for each of a second plurality of questions and at least one open-ended response. Each validation form is received from an evaluator associated with an applicant.

In an embodiment, a system for receiving and evaluating electronic personal statements includes one or more existing application systems, one or more application client systems operably connected to the one or more existing application systems via a LAN connection, a host server operably connected to the one or more application client systems and operably connected to the one or more existing application systems via a data server and a firewall, and one or more applicant client systems operably connected to the host server via a communications network. The host server receives one or more electronic personal statements from the one or more applicant client systems. The system may further include one or more evaluator client systems operably connected to the host server via the communications network. The host server receives one or more validation forms from the one or more evaluator client systems. The system may also include a third party application host operably connecting the host server and the one or more application client systems via the communications network.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIGS. 1a-c depict flowcharts of exemplary methods for creating and verifying an electronic personal statement according to an embodiment of the present invention.

FIG. 2 depicts exemplary task sets for individuals or groups accessing an electronic personal statement according to an embodiment of the present invention.

FIGS. 3a and 3b depict exemplary conceptual and physical system architectures, respectively, hosted by a single hosting company according to an embodiment of the present invention.

FIGS. 4a and 4b depict exemplary conceptual and physical system architectures, respectively, hosted by a third party application processing system according to an embodiment of the present invention.

FIG. 5 depicts an exemplary applicant information model according to an embodiment of the present invention.

FIG. 6 depicts an exemplary entity information model according to an embodiment of the present invention.

FIG. 7 illustrates an exemplary applicant entry screen for motivation and initiative according to an embodiment of the present invention.

FIG. 8 illustrates an exemplary applicant entry screen for leadership according to an embodiment of the present invention.

FIG. 9 illustrates an exemplary applicant entry screen for perseverance according to an embodiment of the present invention.

FIG. 10 illustrates an exemplary applicant entry screen for individual contributions according to an embodiment of the present invention.

FIG. 11 illustrates an exemplary evaluator information screen according to an embodiment of the present invention.

FIG. 12 displays an exemplary applicant information validation screen according to an embodiment of the present invention.

### TECHNICAL DESCRIPTION

The present invention may seek to provide information for applicants based on a set of applicant qualities, behaviors and accomplishments of interest to an entity. The set of qualities, behaviors and accomplishments may pertain to skills needed for a job, the character of an individual, or the academic background of a student.

A standardized Internet-based application form including a set of constrained response-options may be created to determine whether an applicant is qualified for a position to which the application form relates. The response-options may be presented in a scaled system for ease of analysis. Additionally, the application form may provide an open-ended entry space. In this open-ended space, the applicant may provide additional or explanatory information regarding a quality, behavior or achievement in question. The constrained response-options and the open-ended entry space, when completed, form an electronic personal statement.

A validation form may also be used to question individuals associated with the applicant, such as teachers, counselors, employers and others with knowledge of the applicant's background, regarding the same or other pertinent qualities, behaviors or accomplishments of the applicant. The evaluators' responses may be used not only to obtain further information regarding the applicant, but also to verify that the information contained in the applicant's responses is not exaggerated, misleading or untruthful.

The application form and the validation form may each be part of an interactive data tool that permits entities to: (1) view applicant self ratings on each specified quality, behavior or accomplishment; (2) view comments and examples regarding the qualities, behaviors and accomplishments; (3) view the validation forms; (4) measure the applicant's self ratings against other applicants' self ratings, either individually, collectively, or based on a particular trait; (5) measure the applicant's self ratings against normative information such as the self ratings of current employees or currently enrolled students; and/or (6) provide a link to the applicant's additional materials including qualitative and quantitative applicant information. An entity may ensure the reliability and validity of a system implementing an embodiment of the present invention by performing empirical studies.

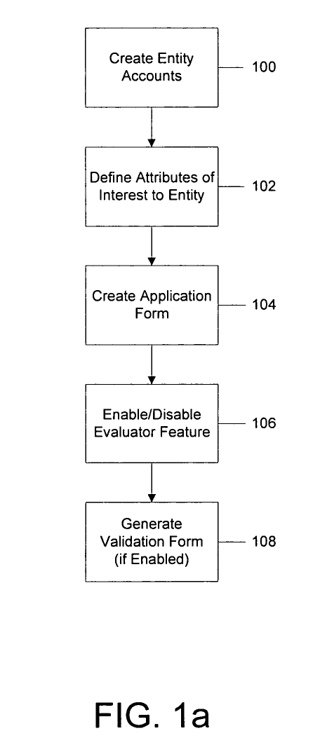

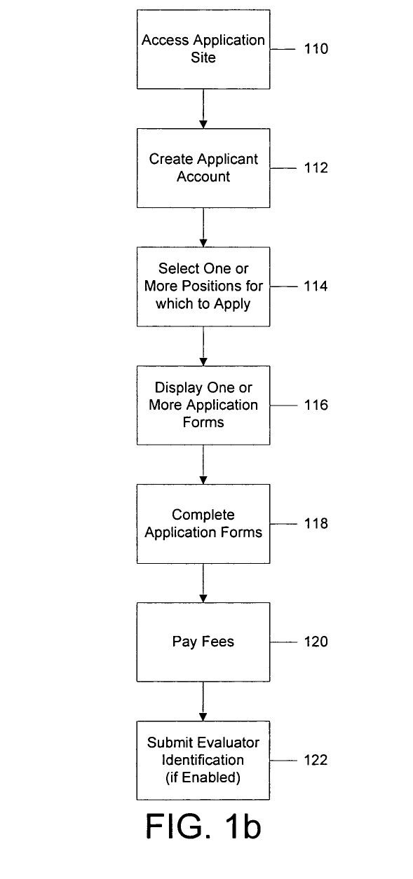

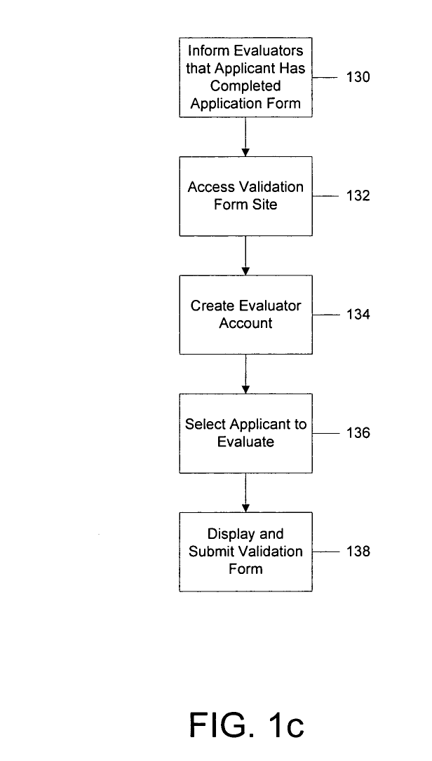

FIGS. 1a-c depict flowcharts of exemplary methods for creating and verifying an electronic personal statement according to an embodiment of the present invention. FIG. 1a depicts a method by which one or more members of an entity create an electronic personal statement template. FIG. 1b depicts a method by which an applicant accesses and completes an electronic personal statement based on the template. FIG. 1c depicts a method by which an evaluator supplements the information in an electronic personal statement completed by an applicant.

Referring to FIG. 1a, one or more members of an entity may create one or more entity accounts 100. The process of creating an entity account 100 may include supplying identifying information for a particular member of the entity, a group of members of the entity or the entity itself. The identifying information may vary based on whether an individual, group or entity may access the entity account 100.

Using the administrator account, the administrator may define 102 one or more qualities, behaviors or accomplishments that are of interest to the entity. The qualities, behaviors or accomplishments may be fixed for a period of time, such as a school year if the entity is a school, or may be variable, such as when an employer redefines requirements for a position. In an embodiment, the period of time may be designated by the entity. Determining which qualities, behaviors or accomplishments to evaluate may be based on a review of previously administered essay topics, application materials and/or employment requirements. The qualities, behaviors and accomplishments of interest to the entity may then be coded and categorized to create 104 an application form containing questions developed to identify applicants possessing the desired qualities, behaviors or accomplishments.

The administrator may select whether to enable or disable an evaluator feature 106. The enabling or disabling of the evaluator feature 106 may be fixed for a period of time, such as a school year if the entity is a school, or may be variable, such as when an employer redefines its hiring process. In an embodiment, the period of time may be designated by the entity. The evaluator feature may be used to verify the applicant from one or more other parties. If the evaluator feature is enabled, an evaluator form may be generated 108 to request information regarding the applicant from the evaluator.

As shown in FIG. 1b, one or more applicants may access, for example, an Internet website containing the application form for the entity 110. The applicant may be prompted to create 112 an applicant account in order to access the application form. The applicant may further select 114 one or more positions to which the applicant is applying. In an embodiment, the one or more positions may be selected 114 from one or more entities. Upon selecting the one or more positions, the application forms for those positions may be displayed 116. In an embodiment, the questions on all of the application forms may be consolidated into one form. By consolidating the forms, the applicant may only have to answer a particular question once even if it appears on more than one application form. Accordingly, the applicant may complete 118 the application forms more quickly. In an embodiment, the applicant may save responses to the application form prior to submission. In this manner, a lengthy application form need not be completed at one time. The applicant may then pay 118 any fees required for submission of the application form. If the evaluator feature is enabled, an applicant may request 120 one or more evaluators to access a validation form by listing the evaluators on the application form.

As shown in FIG. 1c, one or more evaluators may be informed 130 that an applicant has requested them to complete a validation form. The evaluators may then access 132, for example, an Internet website containing the validation form. Alternatively, a validation form may be sent to the evaluator. The validation form may be sent by electronic or physical means. The evaluator may be prompted to create 134 an evaluator account in order to access the validation form. The evaluator may select 136 an applicant that the evaluator has been requested to evaluate. Upon selecting an applicant, the validation forms for the applicant may be displayed 138. In an embodiment, the questions on each validation form corresponding to an application form completed by an applicant may be consolidated into one form. By consolidating the forms the evaluator may only have to answer a question once even if it appears on more than one validation form. Accordingly, the evaluator may complete the validation forms more quickly. In an embodiment, the evaluator may save responses to the validation form prior to submission. In this manner, a lengthy form need not be completed at one time.

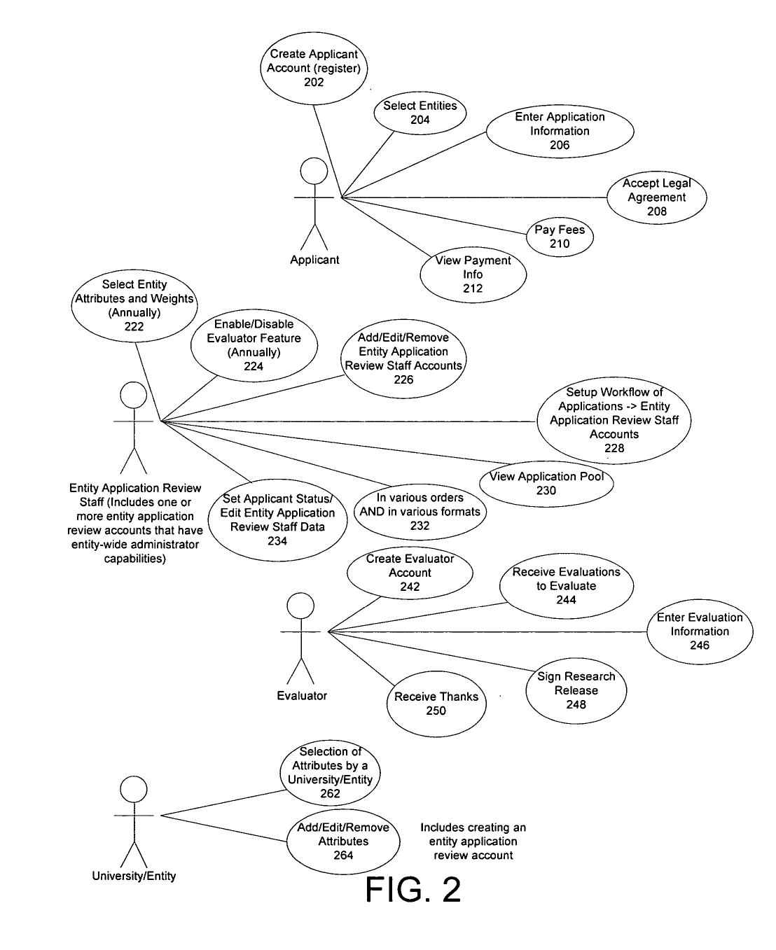

FIG. 2 depicts exemplary task sets for individuals or groups accessing an electronic personal statement according to an embodiment of the present invention. Individuals having access to an electronic personal statement may vary based on the entity to which the personal statement is submitted. In FIGS. 2-12, the requesting entity is an educational entity, such as a university, college, trade school, academy, preparatory school, high school, middle school, elementary school or pre-school. However, the scope of the present invention is not limited to educational entities. The requesting entity may be a business, governmental agency, non-profit entity or any other entity for which applicants attempt to fill open positions.

A first individual requiring access to the electronic personal statement is the applicant 200. Preferably, the applicant 200 may perform one or more tasks. The tasks may include, for example, registering to create an applicant account 202; selecting one or more entities to which the electronic personal statement may be submitted 204; entering information regarding the applicant 206; accepting a legal agreement 208, which, for example, permits the information to be submitted to the one or more schools and/or to be used for statistical purposes; paying fees associated with submitting the electronic personal statement to the one or more schools 210; and viewing payment information 212.

The registration process 202 may require the applicant 200 to provide personal information such as the applicant's name, address and social security number. In addition, other information regarding the applicant's background, such as the applicant's age, ethnicity, net worth, schools attended, date of expected graduation and the like, may be requested as part of the registration process 202.

An applicant 200 may also be required to select one or more entities 204 to which the information is submitted. The one or more entities may be associated with one another, such as the State of California's public university system, or may independently subscribe to an electronic personal statement system covering an individual entity, a consortium of entities, or a state, country, continent or other geographic region.

A second group of individuals who may access the electronic personal statement system may include members of an entity application review staff 220. The entity application review staff 220 may access one or more entity accounts that have entity-wide administrator capabilities. A plurality of staff members 220 may share each entity account. Alternatively, each staff member 220 may have a separate entity account. The staff 220 may perform, for example, one or more of the following tasks on an annual basis: selecting entity attributes and weights 222 and enabling or disabling the evaluator feature 224. The evaluator feature will be discussed in more detail below in reference to the evaluator account 240 and elsewhere in this application.

Entity attributes 222 may include topics for which one or more questions may be presented to an applicant 200. Weights 222 may be assigned to the answers for each attribute 222 based on the importance that the entity application review staff 220 assigns to the attribute 222.

Generally, the attributes 222 may include a set of applicant qualities, behaviors, and accomplishments of interest to the entity. In an embodiment, the set of attributes 222 may be determined based on the research recorded in Stricker and Rock, Measuring Accomplishments: Pseudoipsativity, Quantity vs. Quality and Dimensionality, Educational Testing Service, Princeton, N.J. (April 1996), which is incorporated herein by reference in its entirety.

The entity application review staff 220 may also add, edit or remove application staff accounts 226; setup a workflow of applications to application staff accounts 228, view the pool of applications 230, organize the application pool in various orders, such as by rank, alphabetically or any other order, and in various formats 232, such as on the Internet, in paper form, XML and the like; and set the applicant's status 234 (e.g., “approved,” “hired,” “rejected,” or “waitlisted”).

A third group of individuals which may access the electronic personal statement system may include one or more evaluators 240. An evaluator 240 may validate the information submitted by an applicant 200 by providing independent responses assessing the applicant 200 on the same or similar criteria as presented in the application form.

An evaluator 240 may perform, for example, one or more of tasks on the electronic personal statement system: creating an evaluator account 242; receiving or requesting one or more applications from the electronic personal statement system in order to validate the applicant's responses 244; entering response information 246; signing a research release 248; and receiving appreciation for providing one or more sets of responses 250.

A fourth group of individuals which may access the electronic personal statement system may include one or more universities or entities 260. In an embodiment, a university or entity 260 may oversee the electronic personal statement process for an entire geographic region or a group of related entities. Alternate embodiments may include one or more administrators covering different geographic regions.

The universities or entities 260 may perform, for example, one or more of the following tasks: configuring system-wide options 262 and adding, editing or removing an entity from the system 264. The step of adding, editing or removing an entity from the electronic personal statement system 264 may include creating or removing an entity application review account 220.

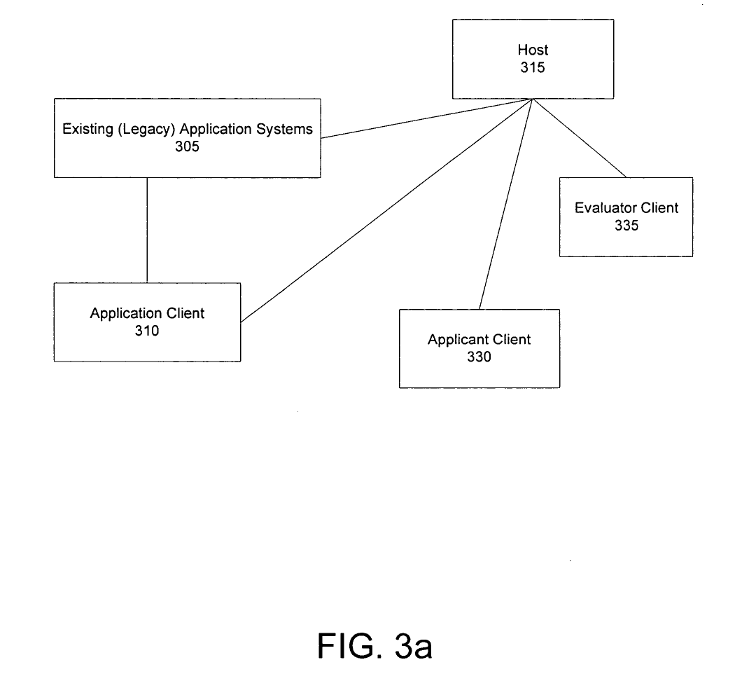

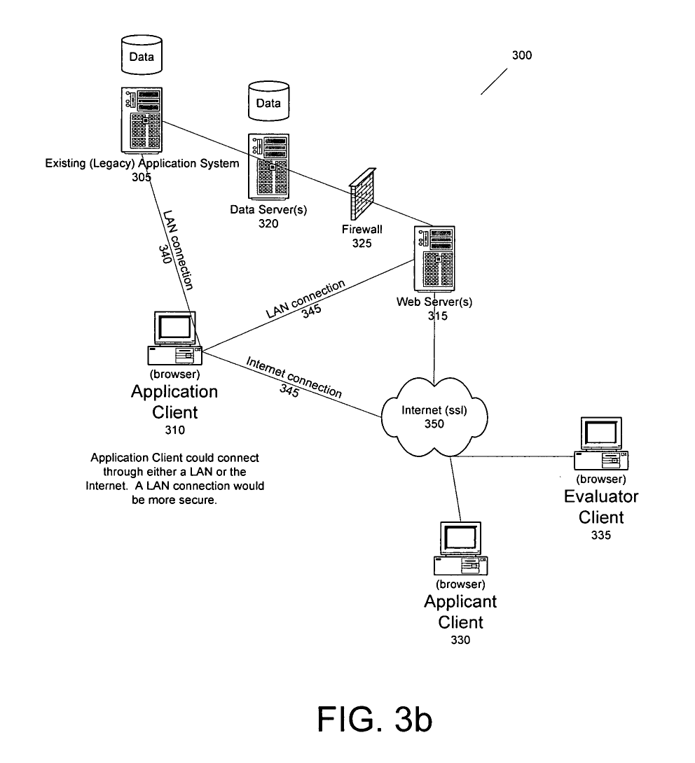

FIGS. 3a and 3b illustrate exemplary conceptual and physical system architectures, respectively, hosted by a single hosting company according to an embodiment of the present invention. The system architecture 300 may include existing application systems 305, an application client 310, and a host server 315. The existing application system 305, the application client 310 and the host server 315 may be interconnected. A LAN connection 340, for example, may connect the application client 310 with the existing application system 305. In addition, the application client 310 may be connected to the host server 315 via a LAN connection 345 and/or via the Internet 350. Preferably, the LAN connection 345 is used to connect the application client 310 and the host server 315 because the LAN connection 345 may be more secure than the Internet connection 350. The existing application system 305 may be connected to the host server 315 via a data server 320 and a firewall 325.

The system 300 may be accessed by one or more applicant clients 330 and, optionally, by one or more evaluator clients 335 (only one of each is shown in FIGS. 3a and 3b). The applicant clients 330 and the evaluator clients 335 may access the host server 315 through a communications network 350, such as the Internet, an intranet, or both. The applicant clients 330 and the evaluator clients 335 may access the host server 315, for example, using a browser application.

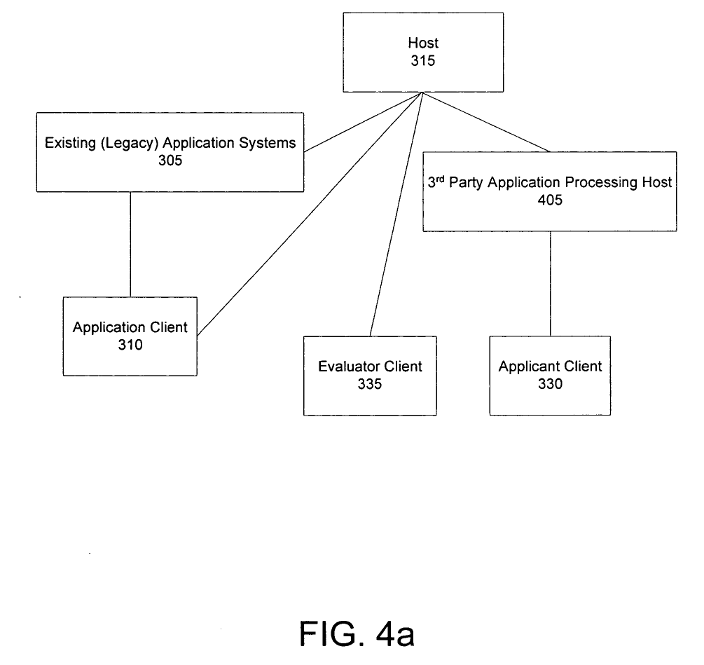

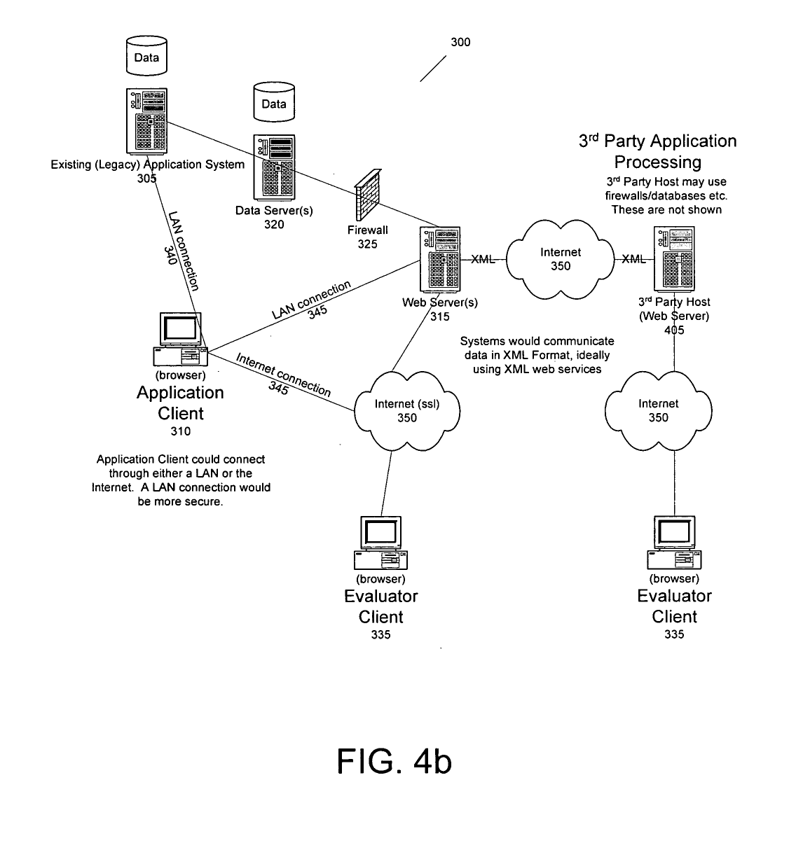

FIGS. 4a and 4b depict an exemplary conceptual and physical system architecture hosted by a third party application processing system according to an embodiment of the present invention, respectively. FIGS. 4a and 4b differ from FIGS. 3a and 3b by the inclusion of a third party application processing host 405, which permits applicant clients 330 to contact the host server 315. An applicant client 330 may access the third party application processing host 405 via a communications network 350, such as the Internet, an intranet, or both. The third party application processing host 405 may include one or more firewalls and one or more databases (not shown). The third party application processing host 405 may transmit data, preferably in an XML format using XML web services, based on the applicant's responses for submission to the host server 315 over the communications network 350.

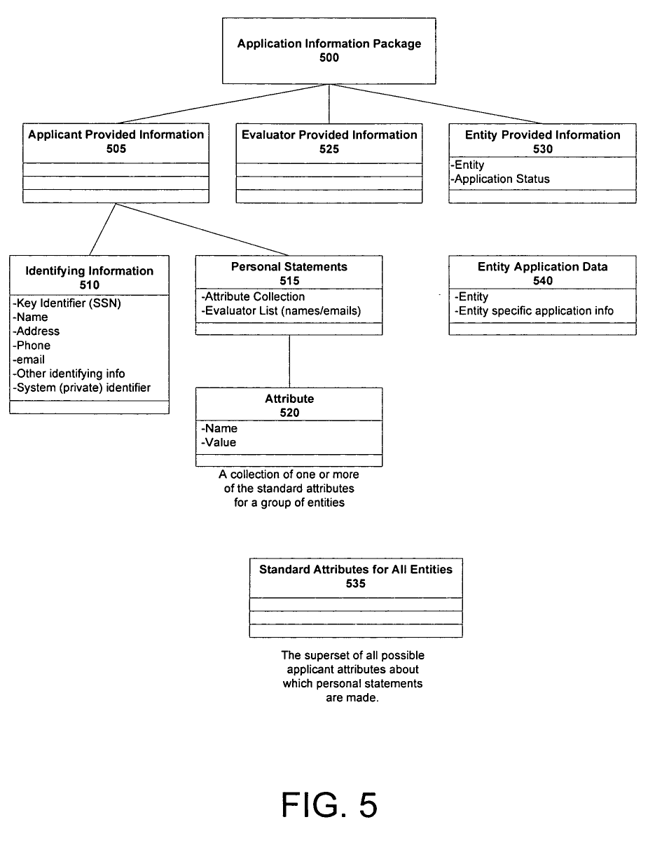

FIG. 5 depicts an exemplary applicant information package model according to an embodiment of the present invention. The applicant information package 500 may include information from one or more of applicant-provided information 505, evaluator-provided information 525, and entity-provided information 530. The applicant-provided information 505 may include identifying information 510 and one or more personal statements 515. The identifying information 510 may include, for example, the applicant's social security number, name, address, phone number, email address, a private electronic personal statement system identifier and other identifying information. Each personal statement 515 may include a set of attributes 520 and, optionally, a list of evaluators 240. Each attribute 520 may have a name and a value associated with it. Each evaluator 240 may be listed by name and contain a record of one or more pieces of identifying information, such as an email address.

Each evaluator 240 may provide evaluator-provided information 525 after being informed of their evaluator status by either the applicant 200 or the electronic personal statement system. The evaluator-provided information 525 may correspond to the personal statement information 515 that the electronic personal statement system requests from the applicant 200.

Entity-provided information 530 may also be associated with each applicant information package 500. The entity-provided information 530 may include an entity and an application status for the applicant 200.

In addition, standard attributes may be defined for all entities 535 using the electronic personal statement system. The standard attributes 535 may represent a superset of all possible applicant ‘attributes’ about which personal statements may be made. Finally, entity application data 540, such as the entity and entity-specific application information, may also be associated with the applicant information package 500.

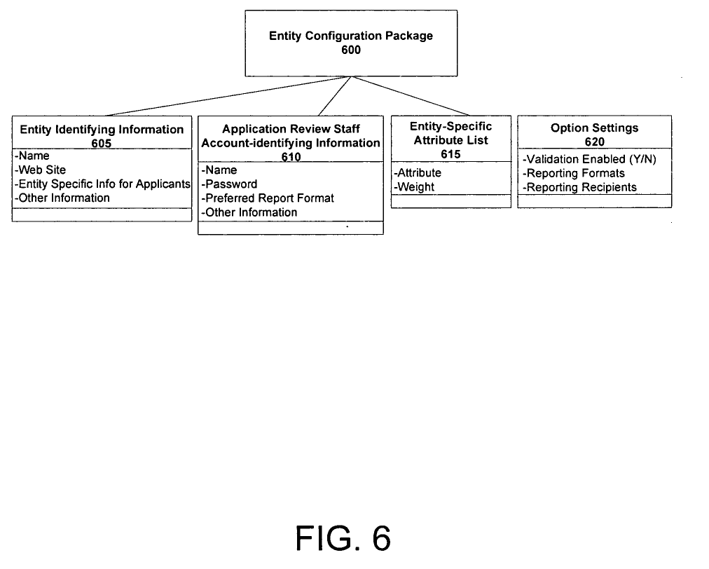

FIG. 6 depicts an exemplary entity information model according to an embodiment of the present invention. An entity configuration package 600 may be used to define a given entity in the electronic personal statement system, the entity application review staff 240 connected with that entity, and other information related to the operation of the system in relation to a particular entity. To that end, the entity configuration package 600 may include, for example, entity-identifying information 605, application review staff account-identifying information 610, an entity-specific attribute list 615, and option settings 620.

Entity-identifying information 605 may include, for example, the entity's name, website URL, physical address, and other contact information. In addition, entity-specific information for applicants may be included as well. Entity application review staff account-identifying information 610 may include an application review staff member's name, password, preferred report format and any other relevant information. The entity-specific attribute list 615 may include one or more attributes and an entity-assigned weight associated with each attribute.

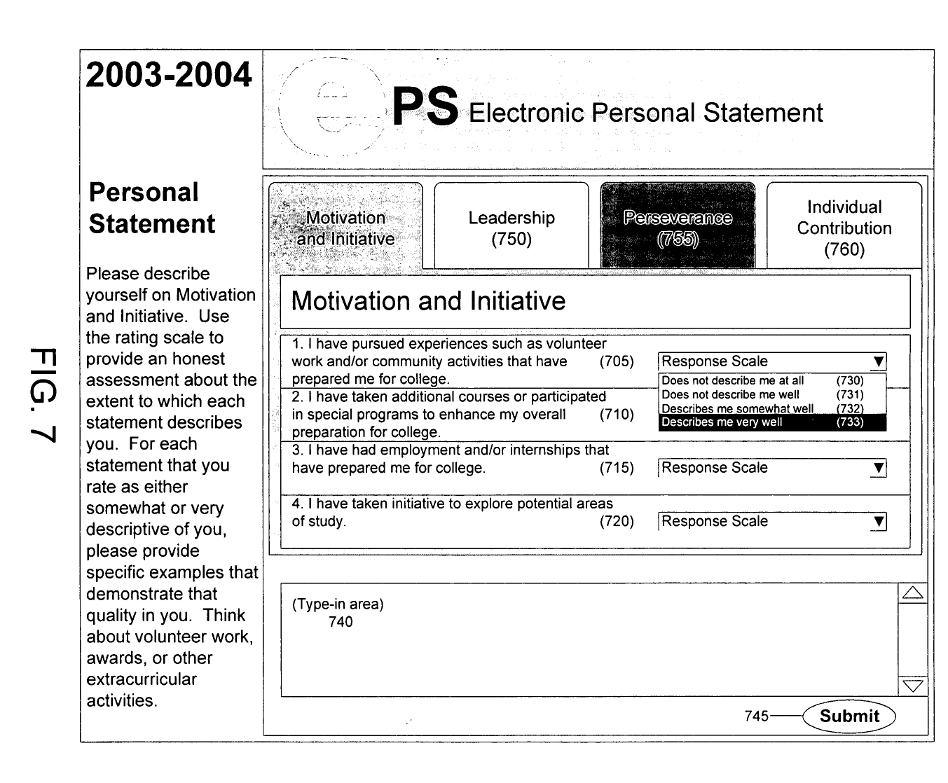

FIG. 7 illustrates an exemplary applicant entry screen for motivation and initiative according to an embodiment of the present invention. The motivation and initiative applicant entry screen 700 may direct the applicant 200 to answer one or more questions regarding attributes pertaining to, for example, the applicant's motivation and initiative to interact in his/her community 705, to pursue additional coursework 710, to pursue employment or internships 715, and/or to pursue new areas of study 720. The applicant 200 may select a rating for each of these questions. In FIG. 7, four ratings are included: “Does not describe me at all” 730, “Does not describe me very well” 731, “Describes me somewhat well” 732, and “Describes me very well” 733. More or fewer ratings may be provided in alternate embodiments. Different rating scales, such as numbers, letters or different comments, may also be provided.

The motivation and initiative applicant entry screen 700 may further include a free response frame 740. The applicant 200 may enter explanatory information in the free response frame 740 regarding the questions and/or attributes listed above. When the applicant 200 has completed the questions on the motivation and initiative applicant entry screen 700, the applicant 200 may press the submit button 745 to exit the page. Alternatively, the applicant 200 may select one of the entry screen tabs on the top of the page 750-760 to select another applicant entry screen 800-1000.

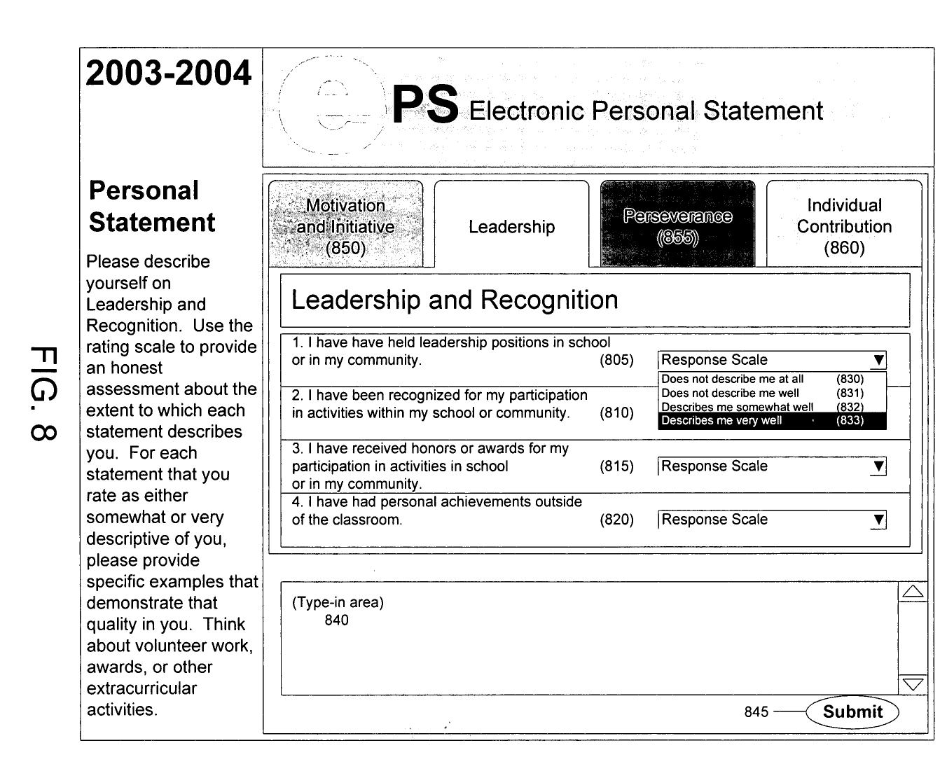

FIG. 8 illustrates an exemplary applicant entry screen for leadership according to an embodiment of the present invention. The leadership applicant entry screen 800 may direct the applicant 200 to answer one or more questions regarding attributes pertaining to, for example, the applicant's leadership in school or community 805, whether the applicant 200 has received recognition for leadership activities 810, whether the applicant 200 has received awards for leadership activities 815, and/or whether the applicant 200 has personal achievements 820. The applicant 200 may select a rating for each of these questions. In FIG. 8, four ratings are included: “Does not describe me at all” 830, “Does not describe me very well” 831, “Describes me somewhat well” 832, and “Describes me very well” 833. More or fewer ratings may be provided in alternate embodiments. Different rating scales, such as numbers, letters or different comments, may also be provided.

The leadership applicant entry screen 800 may further include a free response frame 840. The applicant 200 may enter explanatory information in the free response frame 840 regarding the questions and/or attributes listed above. When the applicant 200 has completed the questions on the leadership applicant entry screen 800, the applicant 200 may press the submit button 845 to exit the page. Alternatively, the applicant 200 may select one of the entry screen tabs on the top of the page 850-860 to select another applicant entry screen 700, 900-1000.

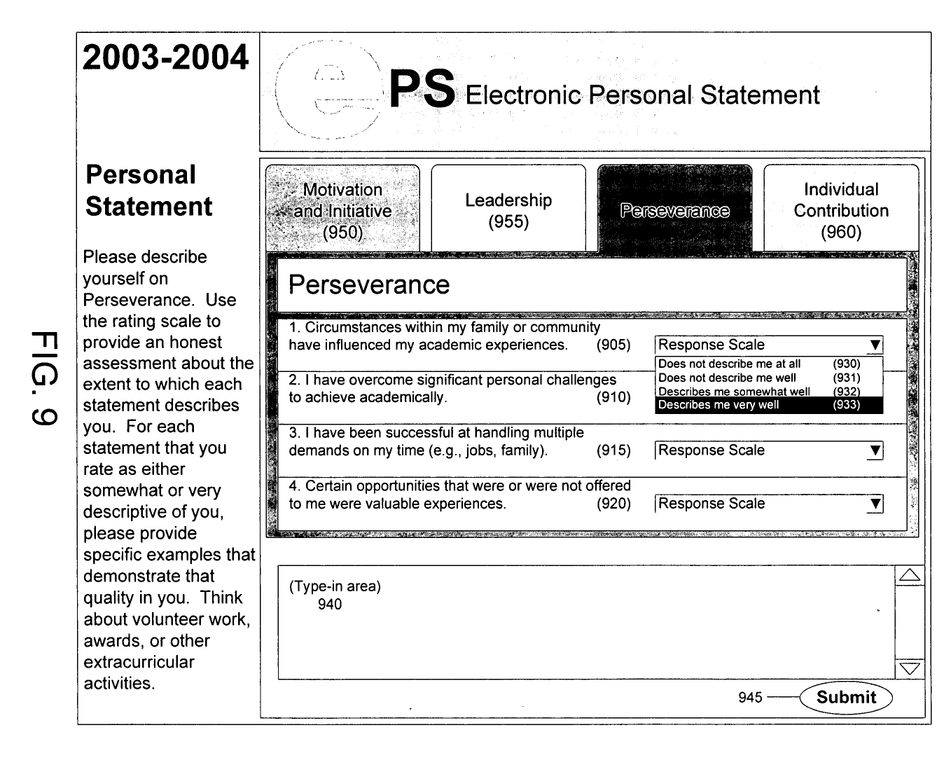

FIG. 9 illustrates an exemplary applicant entry screen for perseverance according to an embodiment of the present invention. The perseverance applicant entry screen 900 may direct the applicant 200 to answer one or more questions regarding attributes pertaining to, for example, the applicant's perseverance with respect to overcoming circumstances within the applicant's family or community 905, overcoming significant personal challenges 910, whether multiple demands have been placed on the applicant 915, and/or whether certain opportunities provided valuable experiences 920. The applicant 200 may select a rating for each of these questions. In FIG. 9, four ratings are included: “Does not describe me at all” 930, “Does not describe me very well” 931, “Describes me somewhat well” 932, and “Describes me very well” 933. More or fewer ratings may be provided in alternate embodiments. Different rating scales, such as numbers, letters or different comments, may also be provided.

The perseverance applicant entry screen 900 may further include a free response frame 940. The applicant 200 may enter explanatory information in the free response frame 940 regarding the questions and/or attributes listed above. When the applicant 200 has completed the questions on the perseverance applicant entry screen, the applicant 200 may press the submit button 945 to exit the page. Alternatively, the applicant 200 may select one of the entry screen tabs on the top of the page 950-960 to select another applicant entry screen 700-800, 1000.

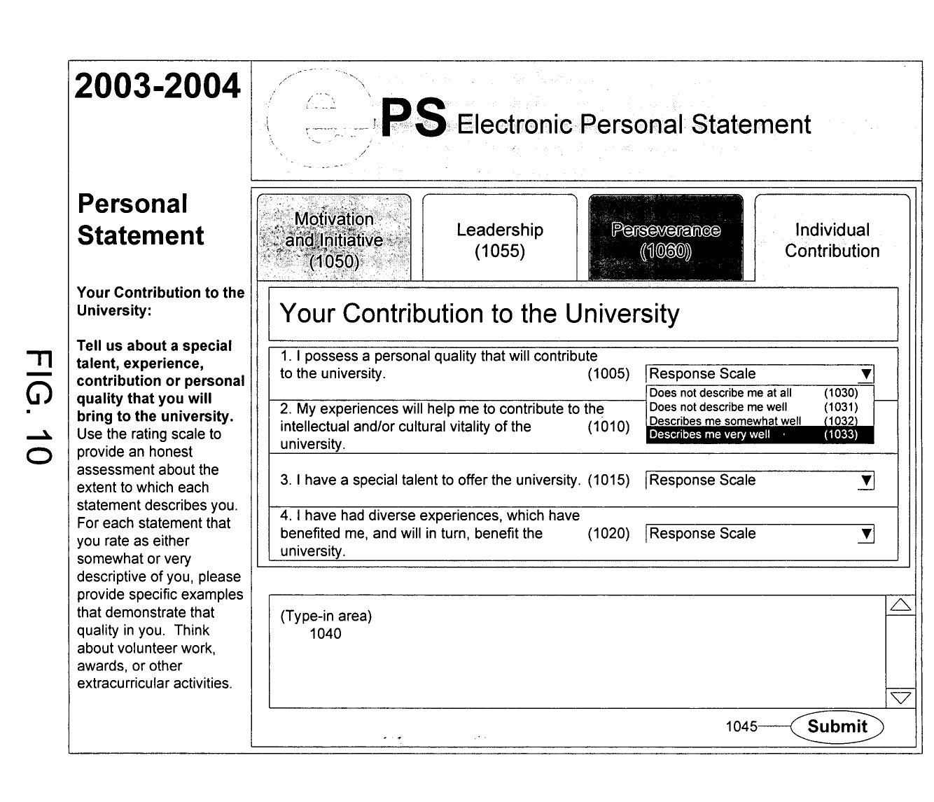

FIG. 10 illustrates an exemplary applicant entry screen for individual contributions according to an embodiment of the present invention. The individual contribution applicant entry screen 1000 may direct the applicant 200 to answer one or more questions regarding attributes pertaining to, for example, a personal quality that will enhance the entity 1005, experiences that will contribute to the vitality of the entity 1010, a special talent 1015, and/or diverse experiences 1020. The applicant 200 may select a rating for each of these questions. In FIG. 10, four ratings are included: “Does not describe me at all” 1030, “Does not describe me very well” 1031, “Describes me somewhat well” 1032, and “Describes me very well” 1033. More or fewer ratings may be provided in alternate embodiments. Different rating scales, such as numbers, letters or different comments, may also be provided.

The individual contribution applicant entry screen 1000 may further include a free response frame 1040. The applicant 200 may enter explanatory information in the free response frame 1040 regarding the questions and/or attributes above. When the applicant 200 has completed the questions on the individual contribution applicant entry screen 1000, the applicant 200 may press the submit button 1045 to exit the page. Alternatively, the applicant 200 may select one of the entry screen tabs on the top of the page 1050-1060 to select another applicant entry screen 700-900.

Other applicant entry screens may be used in replacement of or in addition to the applicant entry screens described above. Moreover, each applicant entry screen may pertain to one or more attributes and may have one or more questions. The applicant entry screens described above are exemplary only and are not meant to limit the scope of the present invention.

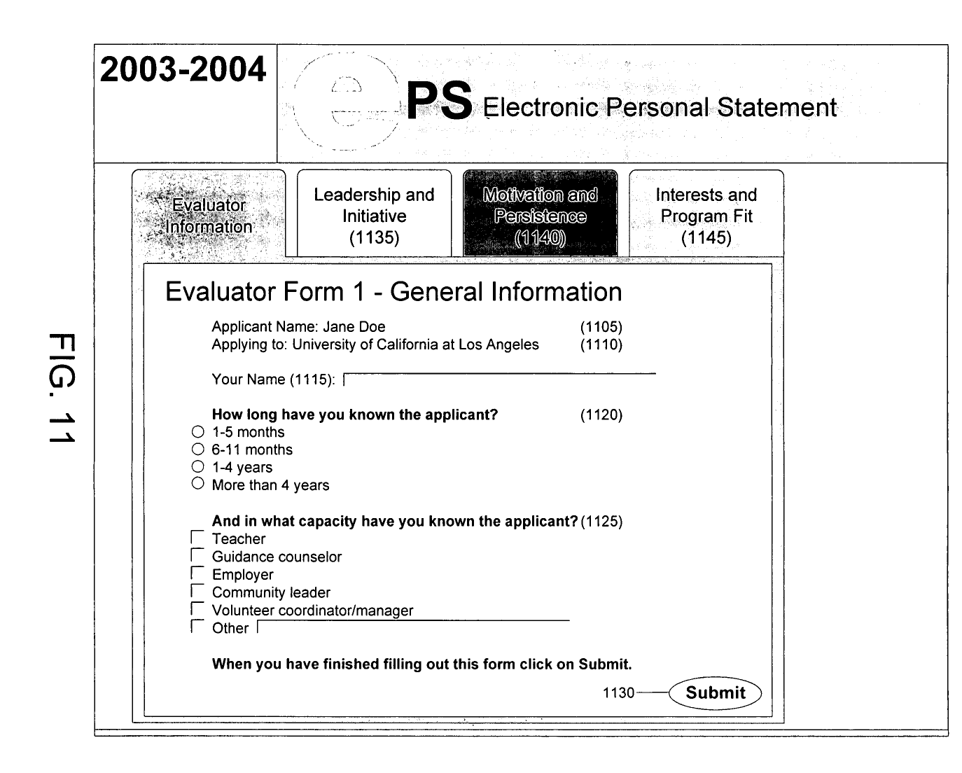

FIG. 11 illustrates an exemplary evaluator information screen according to an embodiment of the present invention. The evaluator information screen 1100 may be used to gather information pertaining to an evaluator 240 of an applicant 200. Responses from evaluators 240 are optional in the present invention, but may be used to assess the applicant 200 more accurately. The evaluator information screen 1100 may include the applicant's name 1105 and the entity 1110 to which the applicant 200 is applying. The evaluator 240 may enter, for example, a name 1115, a length of time 1120 that the evaluator 240 has known the applicant 200, and the capacity 1125 in which the evaluator 240 has known the applicant 200. The length of time 1120 may be broken down into ranges. Exemplary ranges are shown in FIG. 11. Alternatively, a text box may receive text denoting the length of time 1120 that the evaluator 240 has known the applicant 200. One or more potential capacities 1125 in which the evaluator 240 has known the applicant 200 may be listed with checkboxes next to each list item. An evaluator 240 may select the checkbox corresponding to the appropriate capacity 1125. Alternatively, the evaluator 240 may input an unlisted capacity 1125 in an “Other” text box.

Upon entry of the information for the evaluator information screen 1100, the evaluator 240 may click on the submit button 1130 to progress to the next screen. Alternatively, the evaluator 240 may select one of the screen tabs 1135-1145 at the top of the screen to progress to a particular entry screen.

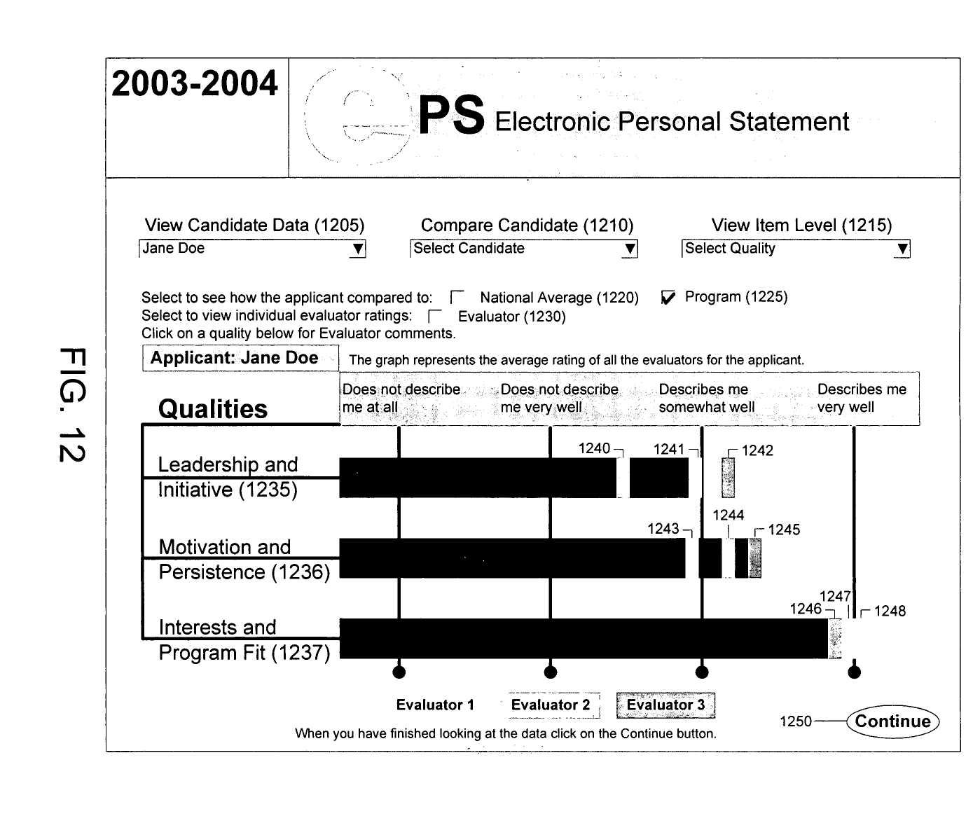

FIG. 12 displays an exemplary applicant validation screen according to an embodiment of the present invention. The applicant validation screen 1200 may present information regarding the applicant's self-assessment and the evaluators' assessments of the applicant 200 with respect to broad applicant qualities. A user may view information pertaining to a particular applicant 200 by selecting the applicant's name from, for example, a drop down menu 1205. A second applicant may be selected from, for example, a second drop down menu 1210 in order to compare the two applicants. If the desired comparison is based on a particular quality, the quality may be selected from, for example, a third drop down menu 1215. Horizontal bars, such as 1235-1237, representing an applicant's rating for a particular quality may be displayed in response to selecting the applicant 200.

An applicant 200 may be compared against a national average 1220 or a program average 1225 of all applicants in requested qualities. If either of these options is selected, vertical bars, such as 1240-1248, may overlay the horizontal bars 1235-1237 representing the 25^{th} percentile, median and 75^{th} percentile of applicants for each quality.

Alternatively, the ratings for all evaluators 240 may be displayed by selecting a checkbox 1230. The average ratings for a quality for each evaluator 240 may be displayed as vertical bars, such as 1240-1248, overlaying the horizontal bars 1235-1237. In this case, particular vertical bars 1240-1248 may denote the rating provided by a particular evaluator 240. Evaluator comments pertaining to a selected applicant 200 may be displayed for a particular quality by selecting the name of the quality, such as by clicking on it with a computer point device. When the viewer has completed viewing the applicant validation screen 1200, the viewer may click on the continue button 1250 to access a subsequent screen.

Although the invention has been described with reference to the preferred embodiments, it will be apparent to one of skill in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method of creating an electronic personal statement, comprising:
defining one or more attributes of interest to an entity;
generating a first plurality of questions based on the one or more attributes, each question having a plurality of response options;
generating an electronic personal statement template including the first plurality of questions; and
receiving, from an applicant, an electronic personal statement having one or more responses for at least one of the first plurality of questions.

2. The method of claim 1, further comprising:
receiving, from the applicant, a fee for processing the electronic personal statement.

3. The method of claim 1, further comprising validating the data entered by the applicant.

4. The method of claim 3 wherein validating the data comprises:
generating a second plurality of questions based on the one or more attributes, each question having a plurality of response options;
generating an electronic validation template based on the second plurality of questions; and
receiving, from an evaluator, an electronic validation form having one or more second responses for at least one of the second plurality of questions.

5. The method of claim 1 wherein defining one or more attributes comprises:
creating one or more entity accounts;
receiving from the entity a selection of the one or more attributes; and
storing the selected one or more attributes in the entity account.

6. The method of claim 5 wherein creating one or more entity accounts comprises receiving information comprising:
identification of the entity; and
identification of one or more individuals authorized to select the one or more attributes on behalf of the entity.

7. The method of claim 5 wherein the one or more attributes are unalterable for a period of time.

8. The method of claim 7 wherein the period of time is designated by the entity.

9. The method of claim 1 wherein generating a first plurality of questions comprises:
categorizing the one or more attributes into one or more categories; and
retrieving one or more questions from a database of questions for each of the one or more categories.

10. The method of claim 1 wherein generating the electronic personal statement template comprises:
listing the first plurality of questions;
listing one or more possible response options for each of the first plurality of questions; and
providing at least one open-ended entry space.

11. The method of claim 10 wherein receiving data from an applicant comprises:
receiving, from the applicant, selected response options to one or more of the first plurality of questions; and
receiving response information entered by the applicant into the at least one open-ended entry space.

12. A method of assessing applicants based on at least an electronic personal statement, the method comprising:
electronically receiving a plurality of electronic personal statements, wherein each electronic personal statement comprises at least one first response-option for each of a first plurality of questions and at least one open-ended response, wherein each electronic personal statement is received from one of a plurality of applicants; and
assessing one or more of the electronic personal statements with respect to one or more attributes.

13. The method of claim 12 wherein assessing one or more of the electronic personal statements comprises:
reviewing the one or more first response-options for each electronic personal statement;
reviewing the at least one open-ended response for each electronic personal statement; and
determining one or more ratings for each electronic personal statement.

14. The method of claim 12 wherein assessing one or more of the electronic personal statements comprises:
comparing at least one first response-option for a first electronic personal statement with at least one corresponding first response-option for one or more second electronic personal statements.

15. The method of claim 12 wherein assessing one or more of the electronic personal statements comprises:
comparing at least one first response-option for an electronic personal statement with normative information.

16. The method of claim 15 wherein normative information comprises response-options submitted by previous applicants.

17. The method of claim 12, further comprising:
electronically receiving one or more validation forms associated with each electronic personal statement, wherein each validation form comprises at least one second response-option for each of a second plurality of questions and at least one open-ended response, wherein each validation form is received from an evaluator associated with an applicant; and
determining whether each second response-option corresponds to at least one first response-option.

18. A system for receiving and evaluating electronic personal statements, the system comprising:
one or more existing application systems;
one or more application client systems operably connected to the one or more existing application systems via a LAN connection;
a host server operably connected to the one or more application client systems and operably connected to the one or more existing application systems via a data server and a firewall; and
one or more applicant client systems operably connected to the host server via a communications network,
wherein the host server receives one or more electronic personal statements from the one or more applicant client systems.

19. The system of claim 18, further comprising:
one or more evaluator client systems operably connected to the host server via the communications network, wherein the host server receives one or more validation forms from the one or more evaluator client systems.

20. The system of claim 18, further comprising:
a third party application host operably connecting the host server and the one or more application client systems via the communications network.
